(19) United States
(12) Patent Application Publication
(10) Pub. No.: US 2026/0025800 A1
(43) Pub. Date: Jan. 22, 2026

(54) INFORMATION TRANSMITTING METHOD, INFORMATION RECEIVING METHOD, REPEATER AND NETWORK DEVICE

(71) Applicant: FUJITSU LIMITED, Kawasaki-shi (JP)

(72) Inventors: Qinyan JIANG, Beijing (CN); Lei ZHANG, Beijing (CN); Yan TIAN, Beijing (CN)

(73) Assignee: FUJITSU LIMITED, Kawasaki-shi (JP)

(21) Appl. No.: 19/346,782

(22) Filed: Oct. 1, 2025

Related U.S. Application Data
(63) Continuation of application No. PCT/CN2023/087160, filed on Apr. 7, 2023.

(51) Int. Cl. H04W 72/0446; H04W 72/231; H04W 72/232

(52) U.S. Cl. CPC H04W 72/0446; H04W 72/231; H04W 72/232

(57) ABSTRACT

A repeater includes: a receiver configured to: receive a RRC signaling including first configuration information, second configuration information and third configuration information, the first configuration information being used to configure a list of time domain resources, the second configuration information being used to configure a radio network temporary identity (RNTI) for scrambling a first DCI format, the third configuration information being used to configure a search space for monitoring the first DCI format; and receive the first DCI format; the first DCI format comprising a first information field used to indicate a beam for access link and a second information field used to indicate a time domain resource from the time domain resources configured by the first configuration information; and a forwarding entity configured to perform forwarding on the access link by using the beam and the time domain resource.

### CROSS-REFERENCE TO RELATED APPLICATION

This application is a continuation application under 35 U.S.C. 111(a) of International Patent Application PCT/CN2023/087160 filed on Apr. 7, 2023, and designated the U.S., the entire contents of which are incorporated herein by reference.

### TECHNICAL FIELD

This disclosure relates to the field of communication technologies.

### BACKGROUND

Compared with legacy 3G (third generation mobile communication technology) and 4G (fourth generation mobile communication technology) systems, a 5G (fifth generation mobile communication technology) system can provide larger bandwidths and higher data rates, and is able to support more types of terminals and vertical services.

For this reason, 5G systems are also deployed at new spectrum in addition to legacy telecommunications spectrum, and frequencies of the spectrum are obviously higher than those of legacy telecommunications spectrum used in 3G and 4G systems. For example, a 5G system may be deployed in a millimeter waveband (such as 28 GHz, 38 GHz, 60 GHz, and higher wavebands).

According to the principle of propagation of wireless signals, the higher a carrier frequency, the more severe a fading experienced by signals during transmission. Therefore, in actual deployment, a 5G system needs a cell coverage enhancement method more than 3G and 4G systems need, especially a 5G system deployed in a millimeter waveband. Hence, how to better enhance cell coverage of a 5G system has become an urgent problem to be solved.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In order to better solve the coverage problem of cellular mobile communication systems in practical deployment, use of a radio frequency (RF) relay/repeater to amplify and forward signals between a terminal equipment (UE) and a network device is commonly used means of deployment. RF repeaters are widely used in actual deployment of 3G and 4G systems. Generally speaking, an RF repeater is a device that amplifies and forwards signals between devices in the RF domain. That is, an RF repeater is a non-regenerative relay node, which only directly amplifies and forwards all received signals.

It was found by the inventors that for a coverage problem encountered in deploying a 5G system, performing coverage enhancement by using a legacy RF repeater is one of feasible solutions. However, as a forwarding behavior of an RF repeater is not controlled by a network, on the one hand, an effect of amplifying and forwarding a target signal by the repeater may possibly be not ideal, and on the other hand, it may pose significant interference to other devices in the network, and increase noise and interference levels of the system, thereby reducing network throughput. Specifically, taking an antenna direction as an example, compared to 2G, 3G and 4G systems, a 5G system adopts the more advanced and complex MIMO (multiple-input multiple-output) technology. In the 5G system, especially for higher carrier frequencies, directional antennas have become basic components of a network device and a terminal equipment. Transmitting and receiving signals based on a beamforming technology is a fundamental signal transmission mode in the 5G system. (Analog) beam directions and widths, etc., of the network device and terminal equipment may dynamically change (i.e. beam switching) due to such factors as changes of positions. However, antennas of a legacy RF repeater may not be dynamically adjusted with respect to directions and have relatively wide beams, and beam directions and beam widths of transmitting and receiving antennas of the RF repeater are unable to flexibly match positions of the network device and terminal equipment and dynamic changes of the beam directions and widths of the transmitting and receiving antennas. If such an RF repeater is configured in the 5G system, on the one hand, its performance/effect of amplifying/enhancing target signals is/are not significant due to that the beam directions and beam widths of its transmitting and receiving antennas do not match the beam directions and beam widths of the network device and terminal equipment, and on the other hand, it may also cause significant interference to other devices (e.g. a network device or a terminal equipment) within a larger range due to use of wider transmitting beams, and increase noise and interference levels of the entire system, thereby reducing network throughput.

A network controlled repeater (NCR) scheme is proposed in 3GPP Rel-18 to enhance NR coverage, so as to forward signals between a network device and a terminal equipment. NCR may directly communicate with the network device via control links to assist in forwarding operations of the NCR.

It was found by the inventors that how to control forwarding operations of the NCR via aperiodic indications especially how to indicate aperiodic forwarding resources has become urgent problem to be solved.

In order to solve at least one of the above problems or other similar problems, embodiments of this disclosure provide an information transmitting method, an information receiving method, a repeater and a network device

According to one aspect of the embodiments of this disclosure, there is provided a network device, including:
a transmitting unit configured to transmit first configuration information and/or second configuration information and/or third configuration information related to a first DCI format to a repeater, wherein the first configuration information is used to configure a list of time domain resources, and/or, the second configuration information is used to configure an RNTI for scrambling the first DCI format, and/or, the third configuration information is used to configure a search space for monitoring the first DCI format; and
the transmitting unit further configured to transmit downlink control information using the first DCI format to the repeater.

According to another aspect of the embodiments of this disclosure, there is provided a repeater, including:
a receiving unit configured to receive first configuration information and/or second configuration information and/or third configuration information related to a first DCI format, wherein the first configuration information is used to configure a list of time domain resources, and/or, the second configuration information is used to configure an RNTI for scrambling the first DCI format, and/or, the third configuration information is used to configure a search space for monitoring the first DCI format; and
the receiving unit configured to receive downlink control information using the first DCI format.

According to a further aspect of the embodiments of this disclosure, there is provided a communication system, including the repeater as described in the another aspect and/or the network device as described in the one aspect.

An advantage of the embodiments of this disclosure exists in that indications for the access link beams and corresponding time domain resources of the repeater may be performed via configuration information in combination with DCI, hence, by controlling the access link beams and corresponding time domain resources of the repeater by the network device, the access link beams and corresponding time domain resources of the repeater in performing forwarding (forwarding downlink/uplink signals) may be enabled to match beams/time domain resources of the terminal equipment receiving/transmitting signals, thereby improving effects of amplifying/enhancing signals, saving power consumption of the repeater, reducing interference to other devices in the network, and improving throughput of the network.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/include/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiments of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a communication system of embodiments of this disclosure;

FIG. 2 is a schematic diagram of an information receiving method of embodiments of this disclosure;

FIG. 3 is a schematic diagram of an information transmitting method of embodiments of this disclosure;

FIG. 4 is a schematic diagram of a repeater of embodiments of this disclosure;

FIG. 5 is a schematic diagram of a network device of an embodiments of this disclosure; and

FIG. 6 is a schematic diagram of an electronic device of an embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a subscriber station (SS), an access terminal (AT), an IAB-MT, or a station, etc.

The terminal equipment may include but not limited to the following devices: a cellular phone, a personal digital assistant (PDA), a wireless modem, a wireless communication device, a hand-held device, an machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

In the embodiments of this disclosure, existing traffics or traffics that may be implemented in the future may be performed between a network device and a terminal equipment. For example, such traffics may include but not limited to enhanced mobile broadband (eMBB), massive machine type communication (mMTC), ultra-reliable and low-latency communication (URLLC), and vehicle to everything (V2X) communication, etc.

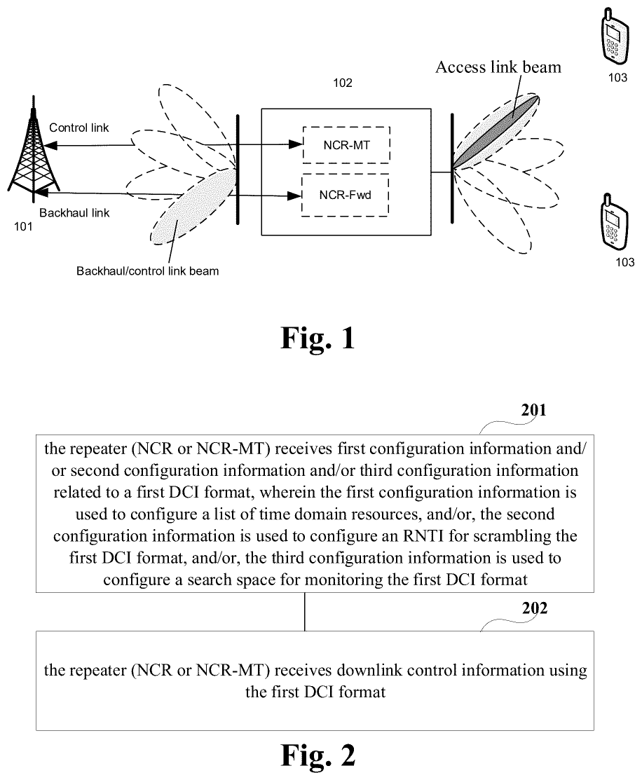

FIG. 1 is schematic diagram of an NCR of embodiments of this disclosure. As shown in FIG. 1, NCR 102 is configured between a network device 101 and a terminal equipment 103. NCR 102 may include the following two modules/components: a mobile termination of the repeater (NCR-MT) and a forwarding unit of the repeater (NCR-Fwd). The NCR-Fwd may also be referred to as a routing unit of the NCR (NCR-RU). The NCR-MT is used for communication with the network device (information exchange), the NCR-Fwd is used for forwarding signals between the network device and the terminal equipment, and the NCR-MT and NCR-Fwd are functional entities, with functions thereof being implemented by identical or different hardware modules.

As shown in FIG. 1, the NCR of the embodiments of this disclosure may have three links: a control link (C-link), a backhaul link (BH-link) for forwarding, and an access link (AC-link, also referred to as an NCR-UE link), wherein the C-link is used for communication between the NCR and the network device, the BH-link is used by the repeater to receive signals to be forwarded from the network device, or forward signals from the terminal equipment to the network device, and the AC-link is used by the repeater to forward signals from the network device to the terminal equipment, or receive signals to be forwarded from the terminal equipment. Specifically, the NCR-MT communicates with the network device via the C-link, and the NCR-Fwd forwards signals via the BH-link and the AC-link.

In the embodiments of this disclosure, the repeater may also be expressed as a network-controlled repeater (NCR), a radio frequency repeater, a relay, a radio frequency relay; or, it may also be expressed as a repeater node, or a relay node; or, it may also be expressed as an intelligent repeater, an intelligent relay, an intelligent repeater node, an intelligent relay node, etc.; however, this disclosure is not limited thereto.

In the embodiments of this disclosure, the network device may be a device of a serving cell of the terminal equipment, or a device in a cell where the repeater is located, or a device of a serving cell of the repeater, or a parent node of the repeater. Names of the repeater are not limited in this disclosure, and any device able to achieve the above functions is included in the scope of the repeater of this disclosure.

In the embodiments of this disclosure, higher-layer signaling may be, for example, radio resource control (RRC) signaling; for example, it includes an RRC message, which includes a master information block (MIB), system information, and a dedicated RRC message; or, it is an RRC information element (RRC IE); or an information field (or an information field included in an information field) included in an RRC message or an RRC information element. Higher-layer signaling may also be, for example, medium access control (MAC) signaling, or referred to as an MAC control element (MAC CE); however, this disclosure is not limited thereto.

In the embodiments of this disclosure, multiple means at least two, or two or more than two.

In the embodiments of this disclosure, “predefined” means defined in a protocol or determined according to a rule defined in a protocol, without needing additional configuration.

Configuration/indication refer(s) to configuring/indicating directly or indirectly by a network device via higher-layer signaling and/or physical layer signaling. Configuration/indication may be performed by introducing a higher-layer parameter into the higher-layer signaling, the higher-layer parameter referring to an information field and/or an information element (IE) in the higher-layer signaling. The physical layer signaling refers to, for example, control information (DCI) carried by a physical control channel or control information carried by a sequence; however, it is not limited thereto.

Implementations of the embodiments of this disclosure shall be described below with reference to the accompanying drawings. These implementations are illustrative only, and are not intended to limit this disclosure.

### Embodiments of a First Aspect

The embodiments of this disclosure provide an information receiving method, which shall be described from a repeater side.

FIG. 2 is a schematic diagram of the information receiving method of the embodiments of this disclosure. As shown in FIG. 2, the method includes:

201: the repeater (NCR or NCR-MT) receives first configuration information and/or second configuration information and/or third configuration information related to a first DCI format, wherein the first configuration information is used to configure a list of time domain resources, and/or, the second configuration information is used to configure an RNTI for scrambling the first DCI format, and/or, the third configuration information is used to configure a search space for monitoring the first DCI format; and

202: the repeater (NCR or NCR-MT) receives downlink control information using the first DCI format.

It should be noted that FIG. 2 only schematically illustrates the embodiments of this disclosure; however, this disclosure is not limited thereto. For example, an order of execution of the operations may be appropriately adjusted, and furthermore, some other operations may be added, or some operations therein may be reduced. And appropriate variants may be made by those skilled in the art according to the above contents, without being limited to what is contained in FIG. 2.

In some embodiments, the DCI (may) has/adopts a first DCI format, the first DCI format being only used for repeaters. The first DCI format or the DCI is used to carry (aperiodic or dynamic) beam indications or side control information, and/or for transmission or notification of (aperiodic/dynamic) beam indications of access links or side control information, and/or for indicating (aperiodic or dynamic) forwarding time resources or forwarding resources, and/or for indicating that the repeater or the forwarding unit of the repeater is on, and/or for indicating that an access link and/or a backhaul link is/are on, and/or, for (aperiodically or dynamically) indicating access link beams and/or time domain resources. The on indicates that the NCR-Fwd (should) forwards signals, or indicates that signals may be forwarded on an access link and/or a backhaul link, including forwarding downlink signals from the network device to the terminal equipment and/or forwarding uplink signals from the terminal equipment to the network device. The first DCI format may be a newly-introduced DCI format (e.g. DCI format 5_0), which is not used for scheduling PDSCHs and/or PUSCHs, and is unicast. However, the embodiments of this disclosure are not limited thereto, and the DCI format may also be an existing DCI format, and/or may be used for scheduling PDSCHs and/or PUSCHs, which is groupcast/multi-cast/broadcast.

In the embodiments of this disclosure, “the downlink control information in the first DCI format” or “the downlink control information using the first DCI format” or “the DCI with the first DCI format” may also be directly referred to as “a first DCI format” in brief, and other DCI formats may also be understood in the same manner.

In some embodiments, the first configuration information and/or the second configuration information and/or the third configuration information may be carried by RRC signaling. The first configuration information related to the first DCI format is used to configure a list of time domain resources, and the DCI with the first DCI format may indicate time domain resources to be forwarded via this list of time domain resources. The list of time domain resources is, for example, a list of aperiodic forwarding time resources for an Fwd (NCR-Fwd) access link; however, it is not limited thereto. The first configuration information includes one or more of the following information: first information used for indicating a first value M; second information used for adding and/or modifying a time domain resource; third information used for releasing a time domain resource; fourth information used for indicating a subcarrier spacing; fifth information used for indicating a bitwidth of the first information field; sixth information used for indicating a bitwidth of the second information field; and seventh information used for indicating a payload size of the first DCI format. The second information field and/or the third information field is/are used to configure a list of time domain resources, that is, the second information (such as ncr-AperiodicFwdTimeResourceToAddModList-r18) may configure time domain resources added and modified in the list of time domain resources, the third information is used to indicate time domain resources released/removed from the time domain resources configured by the second information, the number of time domain resources in the list of time domain resources being able to be determined according to the second information and/or the third information, a subcarrier spacing indicated by the fourth information may be a reference subcarrier spacing of the time domain resources, and the fifth information and sixth information are used to indicate bitwidths of the first information field and second information field, the bitwidths being at least related to a length of the list of time domain resources (configured number and/or the number of the time domain resources), the seventh information indicates the payload size of the first DCI format, which is related to bitwidths of the information fields, that is, related to the length of the list of time domain resources. The first value M indicated by the first information is related to the number(s) of the first information field and/or the second information field, which shall be described later. Wherein, a value range of the bitwidth of the first information field is {1,2,3,4,5,6}, a value range of the bitwidth of the second information field is {0,1,2,3,4,5,6,7} or {1,2,3,4,5,6,7}. A maximum (payload) size of the first DCI format may be 130 bits, and a maximum value of the first value M is 10. When the first configuration information configures the above information, configurations need to be selected from the above value ranges. If at least one of the above information is not configured by the first configuration information, its value range may also refer to the above example, and the embodiments of this disclosure is not limited thereto.

In some embodiments, the time domain resources and forwarding time domain resources or time domain resource configurations or forwarding time domain resource configurations are interchangeable, an index and an ID are interchangeable, and a set and a list are interchangeable.

In some embodiments, the second configuration information is used to configure an RNTI for scrambling the first DCI format or the DCI (or a value of an RNTI used to scramble PDCCHs carrying side control information). For example, the RNTI is NCR-RNTI, and is used to scramble CRC of the DCI. The second configuration information ncr-RNTI-r18 is represented by using ASN. 1:

| PhysicalCellGroupConfig ::= | SEQUENCE { |
|---|---|
| ... | |
| ncr-RNTI-r18 | RNTI-Value |

OPTIONAL, -- Cond NCR

In some embodiments, the third configuration information is used to configure a search space for monitoring the first DCI format. For example, the third configuration information includes tenth information dci-FormatsNCR-r18 used for indicating the NCR-MT to monitor the first DCI format (in the search space configured by the configuration information). The search space in which the first DCI format is monitored is determined according to the third configuration information, and the DCI with the first DCI format is received in the search space. The third configuration information SearchSpace is represented by using ASN. 1:

| SearchSpace ::= | SEQUENCE { |
|---|---|
| ... | CHOICE { |
| searchSpaceType | |
| ... | SEQUENCE { |
| ue-Specific | |
| ... | ENUMERATED {formats5-0} |

```
      dci-FormatsNCR-r18
  OPTIONAL, -- Need R
      ]]
    }
```

In some embodiments, the repeater (NCR-MT) may monitor the first DCI format in a common search space (CSS) and/or a UE specific search space (USS), or, receive the DCI with the first DCI format. That is, the search space configured by the third configuration information is a common search space (CSS) or a UE-specific search space. When there are multiple third configuration information, the types of search spaces (CSSs/USSs) configured by different third configuration information may be identical or different.

In some embodiments, the first DCI format and/or the DCI includes a first information field, and includes or does not include a second information field.

In some embodiments, each/all downlink control information using the first DCI format includes the same number of first information fields and/or second information fields and/or information blocks.

In some embodiments, each/all downlink control information using the first DCI format does not include the second information field.

In some embodiments, different downlink control information using the first DCI format (received by the repeater) may include different numbers of first information fields and/or second information fields and/or information blocks, the different downlink control information refers to downlink control information received at different time domains and/or frequency resources.

For example, the first information field is used to indicate being ON of the forwarding unit of the repeater and/or used to indicate a beam (for the access link of the repeater/the forwarding unit of the repeater), and/or, the second information field is used to indicate (aperiodic) forwarding time resources or time resources, and/or, the information block includes one first information field and one second information field, the first information field and the second information field being associated with each other in a sequential mapping (correspondence).

In some embodiments, the first information field may be referred to as a beam indication/indicator (field) or beam index (field) or beam index indicator/indication (field); however, it is not limited thereto.

In some embodiments, the second information field may be referred to as a time resource indication/indicator (field) or forwarding time resource indication/indicator (field); however, it is not limited thereto.

In some embodiments, the information block may be referred to as a forwarding resource (block), but is not limited thereto.

The first information field shall be described first.

In some embodiments, the first information field indicates a beam by indicating a beam index. The beam refers to an access link beam or a beam for an access link.

In some embodiments, the DCI includes one or more first information fields, wherein one first information field must indicate one beam or at most one beam (i.e. it may not indicate a beam). For example, all first information fields of (having/corresponding to) different sequence numbers must indicate a beam, or may not indicate a beam, or some (such as a first one of first information fields) must indicate a beam, while others (such as first information fields other than the first one) may not indicate a beam.

In some embodiments, the first information field may be set to a third specific value. The third specific value does not correspond to/is not associated with (any) beam or beam index (of (the access link of) the NCR/NCR-Fwd). When the first information field is set to the third specific value, it does not indicate a beam.

The third specific value shall be illustrated below.

In some embodiments, the third specific value may correspond to a fourth value (e.g. a minimum value or a maximum value) of the first information field. For example, taking the binary system as an example, the fourth value is that all bits in the first information field are 0 or 1. For another example, taking the decimal system as an example, the fourth value is 0.

In some embodiments, the third specific value is used to denote/indicate that the first information field and/or a first information field after the first information field do/does not indicate a beam and/or is/are invalid and/or is/are set to a fourth specific value and/or is/are ignored by the repeater, and/or that a second information field to which the first information field corresponds and/or a second information field to which a first information field after the first information field corresponds do/does not indicate time domain resources and/or is/are invalid and/or is/are set to a second specific value and/or is/are ignored by the repeater, and/or that an information field after the first information field is invalid and/or is set to a sixth specific value and/or is ignored by the repeater, and/or that a second information field included in an information block where the first information field is located does not indicate time domain resources and/or is invalid and/or is set to a second specific value and/or is ignored by the repeater, and/or that a second information field included in an information block after the information block where the first information field is located does not indicate time domain resources and/or is invalid and/or is set to a second specific value and/or is ignored by the repeater, and/or that a first information field included in an information block after the information block where the first information field is located does not indicate beams and/or is invalid and/or is set to a fourth specific value and/or ignored by the repeater, and/or the first information field is a last information field (of the downlink control information), and/or the information block where the first information field is located is a last information field (of the downlink control information), and/or the first information field is a last first information field (of the downlink control information), and/or the second information field to which the first information field corresponds is a last second information field (of the downlink control information), and/or the first information field does not have a corresponding second information field.

In some embodiments, a downlink control information in the first DCI format (received by the repeater) includes a first information field set to a third specific value, wherein the first information field and/or a first information field after the first information field do/does not indicate a beam and/or is/are invalid and/or is/are set to a fourth specific value and/or is/are ignored by the repeater, and/or the second information field to which the first information field corresponds and/or the second information field to which a first information field after the first information field corresponds do/does not indicate time domain resources and/or is/are invalid and/or is/are set to a second specific value and/or is/are ignored by the repeater, and/or an information field after the first information field is invalid and/or is set to a sixth specific value and/or is ignored by the repeater, and/or a second information field included in the information block where the first information field is located does not indicate time domain resources and/or is invalid and/or is set to a second specific value and/or is ignored by the repeater, and/or a second information field included in the information block after the information block where the first information field is located does not indicate time domain resources and/or is invalid and/or is set to a second specific value and/or is ignored by the repeater, and/or a first information field included in the information block after the information block where the first information field is located does not indicate beams and/or is invalid and/or is set to a fourth specific value and/or is ignored by the repeater, and/or the first information field is a last information field (of the downlink control information), and/or the information block where the first information field is located is a last information block (of the downlink control information), and/or, the first information field is a last first information field (of the downlink control information), and/or the second information field to which the first information field corresponds is a last second information field (of the downlink control information), and/or the first information field does not have a corresponding second information field.

In some embodiments, one or more first information fields (e.g. the first one of the first information fields) in the first DCI format is/are not (is/are unable/do(es) not allow/is/are not allowed) set to a third specific value, that is, one or more first information fields (e.g. the first one of the first information fields) with identical sequence numbers in each/all of the DCI with the first DCI format is/are not (is/are unable/do(es) not allow/is/are not allowed) set to the third specific value. Taking the first one of the first information fields as an example, it includes that a fourth value of the first one of the first information fields has a corresponding/associated beam or beam index. Therefore, when the first information field is set to the fourth value, it indicates a beam, and is not the third specific value (in this case, it may also be said that the first information field does not include the third specific value). Or, the fourth value does not correspond to/is not associated with (any) beam or beam index (of the (access link of) NCR/NCR-Fwd), but the first information field is unable to be set to the fourth value (in this case, it may also be said that the first information field includes a third specific value, but is unable to be set to the third specific value).

In some embodiments, one or more first information fields should be set to a fourth specific value. Generally, the fourth specific value does not correspond to/is not associated with (any) beam or beam index (of the (access link of) NCR/NCR-Fwd); however, it is not limited thereto, and the fourth specific value may also correspond to a beam or a beam index.

The fourth specific value shall be illustrated below.

In some embodiments, the fourth specific value may correspond to a fifth value (e.g. a minimum value or a maximum value) of the first information field. For example, taking the binary system as an example, the fifth value is that all bits in the first information field are 0 or 1. For another example, taking the decimal system as an example, the fifth value is 0.

In some embodiments, for one or more first information fields (e.g. first information fields other than the first one) in the first DCI format, or, for one or more first information fields (e.g. first information fields other than the first one) with identical sequence numbers in each/all of the downlink control information in the first DCI format, the fourth specific value is a default value used in a specific case, in other words, in this specific case, the first information field must/should be set to that value.

In some embodiments, the specific case may possibly not occur only for a part of the first information fields (such as the first one of the first information fields) in the first DCI format (or the first information fields in each/all downlink control information in the first DCI format with identical sequence numbers). Taking that the specific case does not occur for the first one of the first information fields and may possibly occur for other first information fields (with other sequence numbers) as an example, for the first one of the first information fields, it is not (impossible to/does not allow to be/is not allowed to be) set to the fourth specific value/the fifth value, or when it is set to the fourth specific value/the fifth value, it indicates a beam (in other words, according to the first information field, the NCR determines the beam it indicates and uses the beam). For other first information fields, they are set to the fourth specific value/the fifth value in this specific case, and at this time, the first information field does not indicate a beam (in other words, not according to the first information field, to determine the beam it indicates and use the beam by the NCR).

In some embodiments, for a downlink control information in the first DCI format, for a first information field where the specific case may occur, when the special case occurs, it must/should be set to this value. When the specific case does not occur and it is set to the fourth specific value/the fifth value, it indicates a beam (in other words, according to the first information field, the NCR determines the beam it indicates and uses the beam).

In some embodiments, for a downlink control information using the first DCI format, a first information field (if any) before the first information field therein is set to the third specific value and/or a second information field (if any) before the first information field is set to a first specific value, and/or when a second information field to which the first information field corresponds is set to a second specific value, the first information field is (should be set to be) the fourth specific value (set to a fifth value, not indicating a beam). (The first specific value and the second specific value shall be described later).

The number of the first information fields included in the DCI shall be described in the following embodiments.

The second information field shall be described below.

In some embodiments, when the DCI includes second information fields, one second information field is used to indicate a time domain resource index, or at most indicate one time domain resource index. The index may also be replaced with a sequence number or an identifier (ID). A case where the DCI does not include a second information field shall be described later, and the following description shall be given by taking that the DCI includes the second information fields as an example.

In some embodiments, the DCI or the second information field in the DCI indicates time domain resources based on a list of time domain resources, the list of time domain resources is configured by the above first configuration information.

For example, the number of time domain resources in the list of time domain resources may be determined according to the second information, for example, the number of time domain resources in the list of time domain resources is equal to the number of entries included in the second information.

For example, the list of time domain resources may be configured by the second information and the third information, and the number of time domain resources in the list of time domain resources is equal to the number of time domain resource configurations configured by the second information and having not been released/removed by the third information.

For example, indices of the time domain resources configured by the second information include 1, 2, 3, 4, and an index of a time domain resource indicated by the third information to be released/removed is 1, and the number of time domain resources in the configured list of time domain resources is 3.

It should be noted that the names of the information fields or information elements in the embodiments of this disclosure are examples only, and are not intended to limit the embodiments of this disclosure.

For the convenience of following description, “a first time domain resource set” and “a second time domain resource set” are cited, wherein the first time domain resource set is the configured list of time domain resources as described above, that is, the first time domain resource set is equivalent to the list of time domain resources and includes all time domain resources in the list of the time domain resources, and the second time domain resource set includes some or all of the time domain resources in the list of the time domain resources. The second time domain resource set corresponds to the second information fields in DCI, and configurations (indices) of time domain resources in the second time domain resource set to which the second information fields correspond may be partially identical or completely different, and the embodiments of this disclosure is not limited thereto; or, a second time domain resource set to a second information field corresponds includes time domain resource configurations in the list of the time domain resources or the first time domain resource set that are not indicated by (one or more or all) second information fields before the second information field (if any), or does not include time domain resource configurations in the list of the time domain resources or the first time domain resource set indicated by (one or more or all) second information fields before the second information field (if any). Specifically, for a first one of the second information fields, a second time domain resource set to which it corresponds includes/is equivalent to the time domain resource configurations of the list of the time domain resources or the first time domain resource set. For example, the list of the time domain resources includes time domain resources with indices 1, 2, 3 and 4, a second time domain resource set to which the first one of the second information fields corresponds includes all time domain resources in the list of the time domain resources, i.e. time domain resources with indices 1, 2, 3 and 4, the first one of the second information fields indicates a time domain resource with index 1, and a second time domain resource set to which a second one of the second information fields corresponds includes time domain resources in the list of the time domain resources that are not indicated by the first information field, i.e. time domain resources with indices 2, 3 and 4. Or, a second time domain resource set to which a second information field corresponds includes time domain resources in list of the time domain resources or the first time domain resource set that are not indicated by (one or more or all, if any) second information fields before the second information field, and/or time domain resources that do not overlap (in the time domain) with time domain resources indicated by (one or more or all, if any) second information fields before the second information field, or, in other words, does not include time domain resources indicated by (one or more or all, if any) second information fields before the second information field or time domain resources that overlap (in the time domain) with the indicated time domain resources. For example, the list of the time domain resources includes time domain resources with indices 1, 2, 3 and 4, wherein if time domain resources with indices 1 and 2 are indicated by the same DCI, the two time domain resources will overlap in the time domain. The second time domain resource set to which the first one of the second information fields corresponds includes all time domain resources in the list of the time domain resources, i.e. time domain resources with indices 1, 2, 3 and 4, the first one of the second information fields indicates a time domain resource with index 1, and the second time domain resource set to which the second one of the second information fields corresponds does not include time domain resources with indices 1 and 2 and includes time domain resources with indices 3 and 4 in the list of the time domain resources.

In addition, for the convenience of following description, “a first parameter”, “a second parameter” and “a third parameter” are cited. The first parameter I is equal to the number of time domain resources in the first time domain resource set (the list of time domain resources) or the second time domain resource set, and/or, the second parameter N1 is equal to a predefined second value and/or a second value configured by ninth information and/or is related to the number of first specific values and/or second specific values. For example, the second parameter is determined according to the number of first specific values and/or the number of second specific values, the second parameter is equal to the number of the first specific values, or is equal to the number of the second specific values, or is equal to a sum of the number of the first specific values and the number of the second specific value. And/or, the third parameter N2 is equal to a predefined third value and/or a third value configured by eighth information and/or is related to a position of a second information field. For example, the third parameter is related to the number of second information fields before the second information field and/or a sequence number of the second information field (a sequence number (assuming that the sequence number starts from 0), or a sequence number −1 (assuming that the sequence number starts from 1)). For example, it is equal to the number of second information fields before the second information field, or is equal to the sequence number of the second information field, or is equal to the sequence number −1 of the second information field, or is equal to the number of time domain resources indicated by a second information field before the second information field (in the list of time domain resources or the first time domain resource set or the second time domain resource set to which the second information field corresponds), or is equal to a sum of the number of time domain resources indicated by a second information field before the second information field (in the list of time domain resources or the first time domain resource set or the second time domain resource set to which the second information field corresponds) and time domain resources overlapping with these time domain resources. The ninth information and/or the eighth information is/are configured by RRC signaling, which is carried by, for example, the above first configuration information, or by other information elements or information fields other than the first configuration information, and the embodiments of this disclosure is not limited thereto.

The first specific value shall be described below.

The first specific value does not correspond to/are not associated with (any) time domain resources or time domain resource index (of the (access link of) the NCR/NCR-Fwd). When the second information field is set to the first specific value, it does not indicate time domain resources.

In some embodiments, the first specific value may correspond to a sixth value (e.g. a minimum value or a maximum value) of the second information field. For example, taking the binary system as an example, the sixth value is that all bits in the second information field are 0 or 1. For another example, taking the decimal system as an example, the sixth value is 0.

In some embodiments, the first specific value is used to indicate that the second information field and/or a second information field after the second information field does not indicate time domain resources and/or is/are invalid and/or is/are set to a second specific value and/or is/are ignored by the repeater, and/or that the first information field to which the second information field corresponds and/or a first information field to which a second information field after the second information field corresponds do(es) not indicate beams and/or is/are invalid and/or is/are set to a fourth specific value and/or is/are ignored by the repeater, and/or that information fields after the second information field are invalid and/or are set to a fifth specific value and/or are ignored by the repeater, and/or that a first information field included in the information block where the second information field is located does not indicate a beam and/or is invalid and/or is set to a fourth specific value and/or is ignored by the repeater, and/or that a first information field included in an information block after the information block where the second information field is located does not indicate a beam and/or is invalid and/or is set to a fourth specific value and/or is ignored by the repeater, and/or that a second information field included in an information block after the information block where the second information field is located does not indicate time domain resources and/or is invalid and/or is set to a second specific value and/or is ignored by the repeater, and/or that the second information field is a last information field (of the downlink control information), and/or that the information block where the second information field is located is a last information field (of the downlink control information), and/or that the second information field is a last second information field (of the downlink control information), and/or that a first information field to which the second information field corresponds is a last first information field (of the downlink control information), and/or that the second information field does not have a corresponding first information field.

In some embodiments, a downlink control information in the first DCI format (received by the repeater) includes a second information field set to a first specific value, wherein the second information field and/or a second information field after the second information field do/does not indicate time domain resources and/or is/are invalid and/or is/are set to a second specific value and/or is/are ignored by the repeater, and/or the first information field to which the second information field corresponds and/or the first information field to which a second information field after the second information field corresponds do/does not indicate beams and/or is/are invalid and/or is/are set to a fourth specific value and/or is/are ignored by the repeater, and/or an information field after the second information field is invalid and/or is set to a fifth specific value and/or is ignored by the repeater, and/or a first information field included in the information block where the second information field is located does not indicate beams and/or is invalid and/or is set to a fourth specific value and/or is ignored by the repeater, and/or a first information field included in the information block after the information block where the second information field is located does not indicate beams and/or is invalid and/or is set to a fourth specific value and/or is ignored by the repeater, and/or a second information field included in the information block after the information block where the second information field is located does not indicate time domain resources and/or is invalid and/or is set to a second specific value and/or is ignored by the repeater, and/or the second information field is a last information field (of the downlink control information), and/or the information block where the second information field is located is a last information block (of the downlink control information), and/or, the second information field is a last second information field (of the downlink control information), and/or the first information field to which the second information field corresponds is a last second information field (of the downlink control information), and/or the second information field does not have a corresponding first information field.

In some embodiments, one or more second information fields (e.g. the first one of the second first information fields) in the first DCI format is/are not (is/are unable/do(es) not allow/is/are not allowed) set to a first specific value, that is, one or more second information fields (e.g. the first one of the first information fields) with identical sequence numbers in each/all of the downlink control information in the first DCI format is/are not (is/are unable/do(es) not allow/is/are not allowed) set to the first specific value. Taking the first one of the second information fields as an example, a sixth value of the first one of the second information fields has a corresponding/associated time domain resource or time domain resource index. Therefore, when the second information field is set to the sixth value, it indicates a time domain resource, and is not the first specific value (in this case, it may also be said that the second information field does not include the first specific value). Or, the sixth value does not correspond to/is not associated with (any) time domain resource or time domain resource index (of the (access link of) NCR/NCR-Fwd), but the second information field is unable to be set to the sixth value (in this case, it may also be said that the second information field includes a first specific value, but is unable to be set to the first specific value).

The second specific value shall be illustrated below.

In some embodiments, one or more second information fields should be set to a second specific value. Generally, the second specific value does not correspond to/is not associated with (any) time domain resource or time domain resource index (of the (access link of) NCR/NCR-Fwd); however, it is not limited thereto, and the second specific value may also correspond to a time domain resource or a time domain resource index.

In some embodiments, the second specific value may correspond to a seventh value (e.g. a minimum value or a maximum value) of the second information field. For example, taking the binary system as an example, the seventh value is that all bits in the second information field are 0 or 1. For another example, taking the decimal system as an example, the seventh value is 0.

In some embodiments, for one or more second information fields (e.g. second information fields other than the first one) in the first DCI format, or, for one or more second information fields (e.g. second information fields other than the first one) with identical sequence numbers in each/all of the downlink control information in the first DCI format, the second specific value is a default value used in a specific case, in other words, in this specific case, the second information field must/should be set to that value.

In some embodiments, the specific case may possibly not occur only for a part of the second information fields (such as the first one of the second information fields) in the first DCI format (or the second information fields in each/all downlink control information in the first DCI format with identical sequence numbers). Taking that the specific case does not occur for the first one of the second information fields and may possibly occur for other second information fields (with other sequence numbers) as an example, for the first one of the second information fields, it is not (impossible to/does not allow to be/is not allowed to be) set to the second specific value/the seventh value, or when it is set to the second specific value/the seventh value, it indicates time domain resources (in other words, according to the second information field, the NCR determines the time domain resources it indicates and uses the time domain resources). For other second information fields, they are set to the second specific value/the seventh value in this specific case, and at this time, the second information field does not indicate time domain resources (in other words, not according to the second information field to determine the time domain resources it indicates and use the time domain resources by the NCR).

In some embodiments, for a downlink control information in the first DCI format, for a second information field where the specific case may occur, when the special case occurs, it must/should be set to this value. When the specific case does not occur and it is set to the second specific value/the seventh value, it indicates time domain resources (in other words, according to the second information field, the NCR determines the time domain resources it indicates and uses the time domain resources).

In some embodiments, for a downlink control information using the first DCI format, a second information field (if any) preceding the second information field therein is set to the third specific value and/or a second information field (if any) preceding the second information field is set to a third specific value, and/or when a first information field to which the second information field corresponds is set to a fourth specific value, the second information field is (should be set to be) the second specific value (set to a seventh value, not indicating a time domain resource).

How to indicate time domain resources by the second information field or a correspondence between values of the second information field and the time domain resources in the list of the time domain resources shall be described below.

In some embodiments (I), indices of the time domain resources in the list of the time domain resources or the first time domain resource set or the second time domain resource set may be corresponded starting from a first value of the second information field. An n-th value of a second information field (in the first DCI format or of the DCI) corresponds to a time domain resource with an index configured as n−1 or n in the first time domain resource set or the second time domain resource set (as shown in Table 1 and Table 1 2 below), and/or the n-th value of the second information field corresponds to an n-th time domain resource in the first time domain resource set or the second time domain resource set (as shown in Table 3 and Table 4 below) (where n is an integer greater than or equal to 1). The second information field includes, for example, B bits, that is, a range of bit values of the second information field includes 2^{B} values, wherein the n-th value in the 2^{B} values corresponds to time domain resources in the list of the time domain resources or the first time domain resource set or the second time domain resource set with indices configured as n−1 (assuming that an ID starts from 0) or n (assuming that an ID starts from 1), and/or corresponds to an n-th time domain resource in list of the time domain resources or the first time domain resource set or the second time domain resource set (n is an integer greater than or equal to 1).

TABLE 1

| | | | | |
|---|---|---|---|---|
| Second | Second | Time domain resources | Corresponding | |
| information | information | in the first time domain | indices of the | |
| field | field | resource set or the second | time domain | |
| (bit value) | (decimal value) | time domain resource set | resources | Notes |

| | | | |
|---|---|---|---|
| 00 (1st value) | 0 (1st value) | 1st time domain resource | 0 |
| 01 (2nd value) | 1 (2nd value) | 3rd time domain resource | 1 |
| 10 (3rd value) | 2 (3rd value) | 2nd time domain resource | 2 |
| 11 (4th value) | 3 (4th value) | | |

TABLE 2

| Second | Second | Time domain resources | Corresponding | |
|---|---|---|---|---|
| information | information | in the first time domain | indices of the | |
| field | field | resource set or the second | time domain | |
| (bit value) | (decimal value) | time domain resource set | resources | Notes |
| 00 (1st value) | 0 (1st value) | 1st time domain resource | 0 | |
| 01 (2nd value) | 1 (2nd value) | 3rd time domain resource | 1 | |
| 10 (3rd value) | 2 (3rd value) | 2nd time domain resource | 2 | |
| 11 (4th value) | 3 (4th value) | | | First |
| | | | | specific |
| | | | | value |

TABLE 3

| | | | | |
|---|---|---|---|---|
| Second | Second | Time domain resources | Corresponding | |
| information | information | in the first time domain | indices of the | |
| field | field | resource set or the second | time domain | |
| (bit value) | (decimal value) | time domain resource set | resources | Notes |

| | | | |
|---|---|---|---|
| 00 (1st value) | 0 (1st value) | 1st time domain resource | 0 |
| 01 (2nd value) | 1 (2nd value) | 2nd time domain resource | 1 |
| 10 (3rd value) | 2 (3rd value) | 3rd time domain resource | 3 |
| 11 (4th value) | 3 (4th value) | | |

TABLE 4

| Second | Second | Time domain resources | Corresponding | |
|---|---|---|---|---|
| information | information | in the first time domain | indices of the | |
| field | field | resource set or the second | time domain | |
| (bit value) | (decimal value) | time domain resource set | resources | Notes |
| 00 (1st value) | 0 (1st value) | 1st time domain resource | 0 | |
| 01 (2nd value) | 1 (2nd value) | 2nd time domain resource | 1 | |
| 10 (3rd value) | 2 (3rd value) | 3rd time domain resource | 3 | |
| 11 (4th value) | 3 (4th value) | | | First |
| | | | | specific |
| | | | | value |

In example (I), last one or more (M1) values of the second information field are the first specific value or the second specific value, and M1 is related to the second parameter, for example, M1 is equal to the second parameter N₁.

In some embodiments (II), indices of the time domain resources in the list of the time domain resources or in the first time domain resource set or the second time domain resource set may be corresponded starting from an (n+N₃)-th value of the second information field. An (n+N₃)-th value of the second information field corresponds to a time domain resource with an index configured as n−1 or n in the list of the time domain resources or the first time domain resource set or the second time domain resource set, and/or the (n+N₃)-th value of the second information field corresponds to an n-th time domain resource in the list of time domain resources or the first time domain resource set or the second time domain resource set (as shown in Table 5 and Table 6 below) (where n is an integer greater than or equal to 1). The second information field includes, for example, B bits, that is, a range of bit values of the second information field includes 2^{B} values, wherein the (n+N₃)-th value in the 2^{B} values corresponds to a time domain resource in the list of the time domain resources or the first time domain resource set or the second time domain resource set with an index (ncr-AperiodicFwdTimeResourceId-r18) configured as n−1 (assuming that an ID starts from 0) or n (assuming that an ID starts from 1), and/or corresponds to an n-th time domain resource in the list of the time domain resources or the first time domain resource set or the second time domain resource set (n is an integer greater than or equal to 1).

TABLE 5

| Second | Second | Time domain resources | Corresponding | |
|---|---|---|---|---|
| information | information | in the first time domain | indices of the | |
| field | field | resource set or the second | time domain | |
| (bit value) | (decimal value) | time domain resource set | resources | Notes |
| 00 (1st value) | 0 (1st value) | | | First |
| | | | | specific |
| | | | | value |
| 01 (2nd value) | 1 (2nd value) | 1st time domain resource | 0 | |
| 10 (3rd value) | 2 (3rd value) | 2nd time domain resource | 1 | |
| 11 (4th value) | 3 (4th value) | 3rd time domain resource | 3 | |

TABLE 6

| Second | Second | Time domain resources | Corresponding | |
|---|---|---|---|---|
| information | information | in the first time domain | indices of the | |
| field | field | resource set or the second | time domain | |
| (bit value) | (decimal value) | time domain resource set | resources | Notes |
| 000 (1st value) | 0 (1st value) | | | Second |
| | | | | specific |
| | | | | value |
| 001 (2nd value) | 1 (2nd value) | 1st time domain resource | 0 | |
| 010 (3rd value) | 2 (3rd value) | 2nd time domain resource | 1 | |
| 011 (4th value) | 3 (4th value) | 3rd time domain resource | 3 | |
| 100 (5th value) | 4 (5th value) | 4th time domain resource | 4 | |
| 101 (6th value) | 5 (6th value) | 5th time domain resource | 5 | |
| 110 (7th value) | 6 (7th value) | | | |
| 111 (8th value) | 7 (8th value) | | | First |
| | | | | specific |
| | | | | value |

In example (II), former one or more (N₃) values of the second information field are the first specific value or the second specific value, and N₃ is related to the second parameter, for example, N₃ is equal to the second parameter N₁.

In example (II), former one or more (N₃) values of the second information field are the first specific value or the second specific value, and latter one or more (N₄) values of the second information field are the first specific value or the second specific value, for example, N₃+N₄=N₁.

In some embodiments, the index of the n-th time domain resource in the list of the time domain resources or the first time domain resource set or the second time domain resource set (must/should) is configured to be n (assuming that an ID starts from 1) or n−1 (assuming that an ID starts from 0), or the index of the n-th time domain resource in the list of the time domain resources or the first time domain resource set or the second time domain resource set (must/should) is configured to be different from n or n−1 (where n is an integer greater than or equal to 1).

In the above example, the DCI includes at least one second information field. However, the embodiments of this disclosure are not limited thereto, for example, the DCI may not include a second information field. For example, the list of the time domain resources (or the first time domain resource set or the second time domain resource set) only includes a configuration (index) of one time domain resource, and a bitwidth of the second information field in the DCI is 0 (which shall be described later). That is, the DCI does not include a second information field, in which case the DCI only includes one first information field, and the repeater uses the forwarding time domain resources configured for the Fwd access link by RRC b for forwarding.

The information block in the DCI with the first DCI format and formats of the first information field and the second information field shall be described below.

Example 1: first information field 1, first information field 2 . . . , first information field N_{1,fields}, second information field 1, . . . , second information field 2 . . . , second information field N_{2,fields}. (Numbering may also be started from 0)

Example 2: second information field 1, second information field 2 . . . , second information field N_{2,fields}, first information field 1, . . . , first information field 2 . . . , first information field N_{1,fields}. (Numbering may also be started from 0)

Example 3: first information field 1, second information field 1, first information field 2, second information field 2 . . . first information field N_{1,fields}, second information field N_{2,fields}. (Numbering may also be started from 0)

Example 4: second information field 1, first information field 1, second information field 2, first information field 2, . . . , second information field N_{2,fields}, first information field N_{1,fields}. (Numbering may also be started from 0)

Example 5: the first DCI format includes N_{block} information blocks in an order of block number 1, block number 2, . . . , block number N_{block}. Each block defines one or more first information fields and one or more second information fields. In a block, the first information fields and the second information fields are arranged in the above manner. For example, each block includes one first information field and one second information field, and a first information field and a second information field in the same block correspond to:
block 1: first information field 1, second information field 1 or second information field 1, first information field 1
block 2: first information field 2, second information field 2 or second information field 2, first information field 2
. . .

Block N_{block}: first information field N_{1,fields}, second information field N_{2,fields} or second information field N_{2,fields}, first information field N_{1,fields}.

Before or after the information field in describing the specific values above indicates the above order of arrangement in the DCI.

How to determine/configure the numbers N_{block}, N_{1,fields} and, N_{2,fields} of the second information fields and/or first information fields and/or the information blocks shall be described below.

In some embodiments, a first value related to N_{block}, N_{1,fields}, N_{2,fields} is configured according to the first information in the first configuration information. The first value M is a maximum number Nmax of the first information fields and/or the second information fields that the downlink control information may include and/or an actual number Nac of the first information fields and/or the second information fields that the downlink control information may include.

For example, the first value M is greater than or equal to the number of first information fields and/or the number of second information fields and/or information blocks included in the first DCI format, and/or is greater than or equal to a maximum sequence number (assuming that numbering is started from 1) (or a maximum sequence number+1 (assuming that numbering is started from 0)) of first information fields and/or a maximum sequence number (or a maximum sequence number+1) of second information fields and/or a maximum sequence number (assuming that numbering is started from 1) (or a maximum sequence number+1 (assuming that numbering is started from 0)) of information blocks included in the first DCI format, and/or is greater than or equal to a sequence number (assuming that numbering is started from 1) (or a sequence number+1) of a last first information field and/or a sequence number (or a sequence number+1) of a last second information field and/or a sequence number (or a sequence number+1) of a last information block included in the first DCI format, and/or is greater than or equal to the number of the first information fields and/or the number of second information fields and/or the information blocks included in the DCI, and/or is greater than or equal to a maximum sequence number (assuming that numbering is started from 1) (or a maximum sequence number+1) of the first information fields and/or a maximum sequence number (or a maximum sequence number+1) of the second information fields and/or a maximum sequence number (or a maximum sequence number+1) of the information blocks included in the DCI, and/or is greater than or equal to a sequence number (assuming that numbering is started from 1) (or a sequence number+1 (assuming that numbering is started from 0)) of a last first information field and/or a sequence number (or a sequence number+1) of a last second information field and/or a sequence number (or a sequence number+1) of a last information block included in the DCI.

That is, the first value denotes (or, the first information is used to indicate) the number of first information fields and/or the number of second information fields and/or the number of information blocks included in the first DCI format, and/or, a maximum sequence number (or a maximum sequence number+1) of the first information fields and/or a maximum sequence number (or a maximum sequence number+1) of the second information fields and/or a maximum sequence number (or a maximum sequence number+1) of the information blocks included in the first DCI format, and/or, a sequence number (or a sequence number+1) of a last first information field and/or a sequence number (or a sequence number+1) of a last second information field and/or a sequence number (or a sequence number+1) of a last information block included in the first DCI format, and/or, a maximum number of the first information fields and/or a maximum number of second information fields and/or a maximum number of information blocks possibly included in the DCI, and/or, the number of first information fields and/or the number of second information fields and/or the number of information blocks included in the DCI, and/or, a maximum sequence number (or a maximum sequence number+1) of the first information fields and/or a maximum sequence number (or a maximum sequence number+1) of the second information fields and/or a maximum sequence number (or a maximum sequence number+1) of the information blocks included in the DCI, and/or, a sequence number (or a sequence number+1) of a last first information field and/or a sequence number (or a sequence number+1) of a last second information field and/or a sequence number (or a sequence number+1) of a last information block included in the DCI.

In some embodiments, an index of a latter time domain resource in any two time domain resources in the list of the time domain resources is greater than an index of the former time domain resource therein, or an index of a latter time domain resource in any two time domain resources in the list of the time domain resources is less than an index of the former time domain resource therein.

In some embodiments, when the number Q of the time domain resources included in the list of the time domain resources is less than the first value M or the number(s) of the first information fields and/or the second information fields and/or the information blocks in the first DCI format, a part of the second information fields (such as former Q second information fields) are used to indicate time domain resources.

In some embodiments, the numbers of the first information fields and/or the numbers of the second information fields and/or the numbers of the information blocks included in each/all DCI using the first DCI format are all equal to the first value. For example, the list of the time domain resources (or the first time domain resource set or the second time domain resource set) only includes configurations (indices) of multiple time domain resources, and the bitwidth of the second information fields of the DCI is not 0 (a specific calculation method shall be described later), in which case the number of first information fields and/or the number of second information fields included in the DCI is/are equal to the first value.

In some embodiments, the number of first information fields and/or the number of second information fields included in each/all DCI with the first DCI format are less than the first value. For example, the list of the time domain resources (or the first time domain resource set or the second time domain resource set) only includes a configuration (index) of one time domain resource, and the bitwidth of the second information fields of the DCI is 0 (a specific calculation method shall be described later), in which case the DCI does not include the second information fields, and only includes one first information field. In this case, M configured by the first information must be equal to 1, and the number of the first information fields and/or the second information fields included in the DCI is/are less than the first value.

In some embodiments, the number of the first information fields and/or the number of the second information fields and/or the number of information blocks included in a DCI with the first DCI format may be less than or equal to the first value.

In some embodiments, the number of the first information fields and/or the number of the second information fields and/or the number of information blocks included in a DCI with the first DCI format is/are related to a value/values of the first information fields and/or the second information fields included in the DCI.

In some embodiments, the number of second information fields included in each/all DCI with the first DCI format is related to the list of the time domain resources.

For example, the list of the time domain resources (or the first time domain resource set or the second time domain resource set) only includes a configuration (index) of one time domain resource, the value of the second information field of the DCI includes the first specific value or the second specific value, and a bitwidth thereof is not zero (a specific calculation method shall be described later). In this case, the number of the first information fields and/or the number of the second information fields included in the DCI may be equal to the first value. However, in a case where the value of the second information field of the DCI does not include the first specific value or the second specific value and the bitwidth is 0 (a specific calculation method shall be described later), the number of the first information fields and/or the number of the second information fields included in the DCI is/are less than the first value.

For example, when M is configured as 4 by the first information, the numbers and values of the first information fields and second information fields in the DCI may be as shown in Table 7 below:

TABLE 7

| | | | | | | | | | |
|---|---|---|---|---|---|---|---|---|---|
| Case | Field | Field | Field | Field | Field | Field | Field | Field | Padding |
| 1 | A-1 | B-1 | A-2 | B-2 | A-3 | B-3 | A-4 | B-4 | bits |
| | | | | | | | | | (included |
| | | | | | | | | | or not |
| | | | | | | | | | included) |
| Case | Field | Field | Field | Field | Field | Field | Field | Field | Padding |
| 2 | A-1 | B-1 | A-2 | B-2 | A-3 | B-3 | A-4 | B-4 | bits |
| | | | | | (first | (does not | (first | (does not | |
| | | | | | specific | indicate | specific | indicate | |
| | | | | | value) | beams and/ | value) | beams and/ | |
| | | | | | | or is | | or is | |
| | | | | | | invalid; | | invalid; | |
| | | | | | | and/or, | | and/or, | |
| | | | | | | fourth | | fourth | |
| | | | | | | specific | | specific | |
| | | | | | | value) | | value) | |
| Case | Field | Field | Field | Field | Field | Field | Field | Field | Padding |
| 3 | A-1 | B-1 | A-2 | B-2 | A-3 | B-3 | A-4 | B-4 | bits |
| | | | | | (first | (does not | (does not | (does not | |
| | | | | | specific | indicate | indicate | indicate | |
| | | | | | value) | beams and/ | time | beams and/ | |
| | | | | | | or is | domain | or is | |
| | | | | | | invalid; | resources | invalid; | |
| | | | | | | and/or, | and/or | and/or, | |
| | | | | | | fourth | is invalid; | fourth | |
| | | | | | | specific | and/or, | specific | |
| | | | | | | value) | second | value) | |
| | | | | | | | specific | | |
| | | | | | | | value) | | |

| | | | | | | |
|---|---|---|---|---|---|---|
| Case | Field | Field | Field | Field | Field | Padding bits |
| 4 | A-1 | B-1 | A-2 | B-2 | A-3 | |
| | | | | | (first | |
| | | | | | specific | |
| | | | | | value) | |

In the above cases, FieldA and FieldB respectively denote the first information field and the second information field, or respectively denote the second information field and the first information field. Following description shall be given by taking that FieldA is the second information field and FieldB is the first information field as an example. In case 1, the DCI includes 4 first information fields and 4 second information fields, and values of the first information fields and the second information fields are not the first specific value or the second specific value or the third specific value or the fourth specific value. In case 2, the DCI includes 4 first information fields and 4 second information fields, and values of a third FieldA and a fourth FieldA are the first specific value, indicating that a subsequent FieldB does not indicate a beam and/or is invalid and/or has a fourth specific value (identical to or different from the third specific value). In case 3, the DCI includes 4 first information fields and 4 second information fields, and a value of a third FieldA is the first specific value, indicating that a subsequent FieldB does not indicate a beam and/or is invalid and/or has a fourth specific value (identical to or different from the third specific value), and an FieldA thereafter does not indicate time domain resources and/or is invalid and/or has a second specific value (identical to or different from the first specific value). In case 4 (where M is configured as a maximum number, but not an actual number), the DCI includes 3 FieldA and 2 FieldB, and a value of a third FieldA has a first specific value, indicating that the third FieldA is a last information field.

How to determine the bitwidth of the second information field shall be described below.

In some embodiments, the bitwidth of the second information field is the number B of bits included in the second information field, and bitwidths of the one or more second information fields may be determined according to the sixth information. Bitwidths of first information fields with identical sequence numbers in each/all downlink control information using the first DCI format (received by the repeater) are identical, and/or bitwidths of second information fields therein with identical sequence numbers are identical.

In some embodiments, the bitwidth of the second information field is at least related to a length of a corresponding list of the time domain resources or first time domain resource set or second time domain resource set (i.e. the number of included configurations/time domain resources). The bitwidth of the second information field is greater than or equal to or not less than ┌log₂(I)┐ bits, or ┌log₂(I+N₁)┐ bits, or ┌log₂ (I−N₂)┐ bits, or ┌log₂(I+N₁−N₂)┐ bits. That is, the bitwidth indicated by the sixth information must be greater than or equal to or not less than the bitwidth determined by the above formula.

In some embodiments, the repeater (NCR or NCR-MT) determines the bitwidth of (one or more or each) second information field (of the first DCI format or DCI) according to the first parameter I and/or the second information and/or the third information and/or the second parameter N₁ and/or the third parameter N₂ and/or the fourth parameter O. The bitwidth of the second information field is greater than or equal to or less than ┌log₂(I)┐ bits.

In some embodiments, the bitwidth of the second information field is equal to ┌log₂(I)┐ bits, or ┌log₂(I+N₁)┐ bits, or ┌log₂(I−N₂)┐ bits, or ┌log₂(I+N₁−N₂)┐ bits, or ┌log₂ (I+N₁−N₂−O)┐ bits; where, the fourth parameter O denotes the number of time domain resources in the list of the time domain resources or the first time domain resource set or the second time domain resource set that overlap with time domain resources indicated by (one or more) second information field(s) before the second information field, or in other words, it is equal to a sum of time domain resources (in the list of the time domain resources or the first time domain resource set or the second time domain resource set) overlapping with time domain resources indicated by a second information field before the second information field.

In some embodiments, for second information fields with different sequence numbers, formulae for determining the bitwidth are different, or, formulae are identical but values of the parameters are different. Or, second information fields with different sequence numbers, formulae and values for determining the bitwidth are identical. For example, in the case where the DCI with the first DCI format includes multiple second information fields, a bitwidth and/or formula for determining the bitwidth of a first one of the second information field is/are different from that/those of one or more subsequent second information fields, and/or, bitwidths and/or formulae for determining the bitwidths of two or more second information fields in subsequent multiple second information fields are different, such as being separately/independently determined according to values of the first/second/third/fourth parameters.

In some embodiments, bitwidths of all second information fields are determined based on the same formula. For example, the bitwidths of the information fields are determined based on a formula ┌log₂(I+N₁−N₂)┐; where, parameters I and N₁ are identical for each second information field, but N₂ is related to a position of the second information field. Therefore, it is possible that N₂ is different for different second information fields, which may result that bitwidths obtained through calculation are different. However, the embodiments of this disclosure are not limited thereto, and N₂ may be identical for different second information fields (such as when the second information fields do not include the second specific value), which shall not be enumerated herein any further.

In some embodiments, bitwidths of different second information fields are determined based on different formulae. For example, a formula for determining a bitwidth of a first one of the second information fields is different from that/those of one or more subsequent second information fields, the formula for determining a bitwidth of the first one of the second information fields is ┌log₂(I)┐, and a formula used by subsequent second information fields is ┌log₂(I+N₁)┐ (i.e. the first one of the second information fields may not be set to the first specific value, but other second information fields may be set to the first specific value). The first parameter I denotes the number of time domain resources in the list of the time domain resources, and the second parameter N₁ is equal to the number(s) of the first specific value and/or the second specific value of the second information field (such as equal to 1). That is, when formula ┌log₂(I+N₁)┐ is used, the DCI needs to include at least one second information field.

For example, the first parameter denotes the number of time domain resources in the list of the time domain resources, and the bitwidth of the second information field is equal to ┌log₂(I)┐ bits. Especially when I is equal to 1, the bitwidth of the second information field is 0. That is, when the list of the time domain resources includes only one time domain resource (even if the value indicated by the first information is greater than or equal to 1), the DCI does not include a second information field (for example, the second information field cannot be set to the first specific value or the second specific value), and includes only one first information field.

For example, formulae for determining different second information fields are identical, but values of parameters in the formulae are different. The first parameter denotes the number of time domain resources in the second time domain resource set to which the second information fields correspond, and the bitwidth of the second information fields is equal to ┌log₂(I)┐ bits. For example, for the first one of the second information fields, the number of time domain resources in the second time domain resource set to which it corresponds is I1, and the bitwidth of the first one of the second information fields is equal to ┌log₂(I1)┐ bits. For a second one of the second information fields, the number of time domain resources in the second time domain resource set to which it corresponds is I2, and a bitwidth of the second one of the second information fields is equal to ┌log₂(I2)┐ bits, and so on. For example, I1 and I2 may not overlap completely, or I1 may be equal to the number of the time domain resources in the list of the time domain resources, and I2 is equal to the number of the time domain resources in the list of time domain resources—I1 (for example, the second information field cannot be set to the first specific value or the second specific value).

For example, formulae for determining different second information fields are identical, but values of parameters in the formulae are different. The first parameter I denotes the number of time domain resources in the second time domain resource set to which the second information fields correspond. The second parameter N₁ is equal to the number(s) of the first specific values and/or the second specific values of the second information field. The bitwidth of the second information field is equal to ┌log₂(I+N₁)┐ bits. For example, for a first one of the second information fields, the number of time domain resources in the second time domain resource set to which it corresponds is I1, and the bitwidth of the first one of the second information fields is equal to ┌log₂ (I+N₁)┐ bits. For a second one of the second information fields, the number of time domain resources in the second time domain resource set to which it corresponds is I2, and a bitwidth of the second one of the second information fields is equal to ┌log2(I2+N1)┐ bits, and so on. For example, I1 and I2 may not overlap completely, or I1 may be equal to the number of the time domain resources in the list of the time domain resources, and I2 is equal to the number of the time domain resources in the list of time domain resources—I1 (for example, the second information field can be set to the first specific value or the second specific value).

For example, formulae for determining different second information fields are different, and values of parameters in the formulae are also different. The first parameter I denotes the number of time domain resources in the second time domain resource set to which the second information fields correspond. For example, a first one of the second information fields will not be set to the first specific value and/or the second specific value, and a bitwidth of the first one of the second information fields is equal to ┌log₂(I1)┐ bits, a value of a second one of the second information fields includes the first specific value and/or the second specific value, and a bitwidth of the second one of the second information fields is equal to ┌log₂(I2+N₁)┐ bits.

What described above is an example only, and the embodiments of this disclosure are not limited thereto.

In some embodiments, (the NCR or NCR-MT expects that) the list of the time domain resources includes at least one time domain resource or at least two time domain resources. For example, by including configurations of at least two time domain resources in the list of time domain resources, a case where the bitwidth of the second information field is 0 may be avoided, thereby avoiding that the second information field is not included.

In some embodiments, in order to support that different second information fields indicate different time domain resources in a case where all second information fields indicate time domain resources, the number of time domain resources included in the list of time domain resources and/or the number of the fourth information and/or entries included in the second information and/or the number of time domain resources configured by the second information and not released/removed by the third information is/are greater than or equal to the number of the second information fields included in the downlink control information and/or the number of the first information fields included in the downlink control information and/or number configured by the first information; and/or,
in order to support that different second information fields indicate different non-overlapped time domain resources in a case where all second information fields indicate time domain resources, the number of non-overlapped time domain resources included in the list of time domain resources and/or the number of the fourth information and/or entries of configurations as being non-overlapped included in the second information and/or the number of non-overlapped time domain resources configured by the second information and not released/removed by the third information is/are greater than or equal to the number of the second information fields included in the downlink control information and/or the number of the first information fields included in the downlink control information and/or the number configured by the first information.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

According to the embodiments of this disclosure, indications for the access link beams of the repeater and corresponding time domain resources may be performed via configuration information in combination with DCI, hence, by controlling the access link beams and corresponding time domain resources of the repeater by the network device, the access link beams and corresponding time domain resources of the repeater in performing forwarding (forwarding downlink/uplink signals) may be enabled to match beams/time domain resources of the terminal equipment receiving/transmitting signals, thereby improving effects of amplifying/enhancing signals, saving power consumption of the repeater, reducing interference to other devices in the network, and improving throughput of the network.

### Embodiments of a Second Aspect

The embodiments of this disclosure provide an information transmitting method, which shall be described from a network device side, with contents identical to those in the embodiments of the first aspect being not going to be described herein any further.

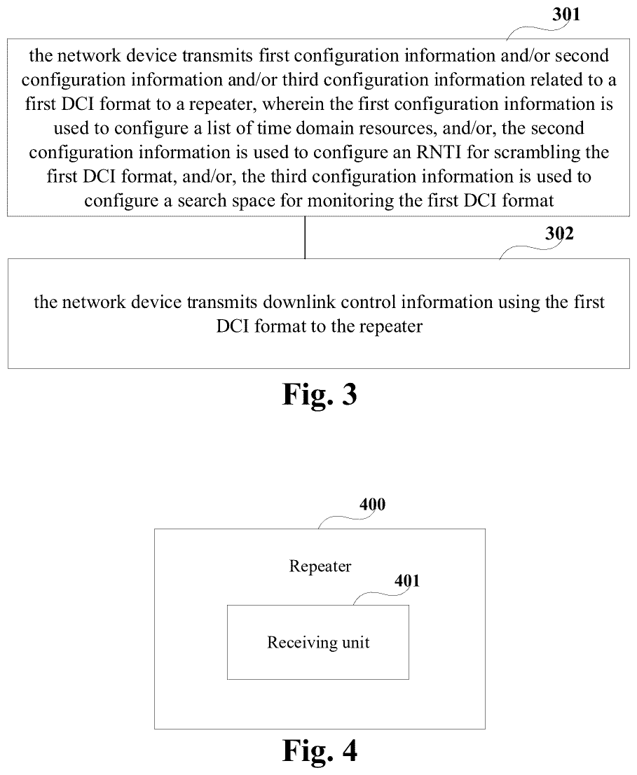

FIG. 3 is a schematic diagram of the information transmitting method of the embodiments of this disclosure. As shown in FIG. 3, the method includes:
301: the network device transmits first configuration information and/or second configuration information and/or third configuration information related to a first DCI format to a repeater, wherein the first configuration information is used to configure a list of time domain resources, and/or, the second configuration information is used to configure an RNTI for scrambling the first DCI format, and/or, the third configuration information is used to configure a search space for monitoring the first DCI format; and
302: the network device transmits downlink control information using the first DCI format to the repeater.

It should be noted that FIG. 3 only schematically illustrates the embodiments of this disclosure; however, this disclosure is not limited thereto. For example, an order of execution of the operations may be appropriately adjusted, and furthermore, some other operations may be added, or some operations therein may be reduced. And appropriate variants may be made by those skilled in the art according to the above contents, without being limited to what is contained in FIG. 3.

Reference may be made to the embodiments of the first aspect for implementations of the configuration information and downlink control information.

The steps or processes related to this disclosure are only described above; however, this disclosure is not limited thereto. The method of the embodiments of this disclosure may also include other steps or processes, and reference may be made to relevant techniques for specific contents of these steps or processes.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Third Aspect

The embodiments of this disclosure provide a repeater. The repeater may be, for example, the NCR as described above, or a network device or terminal equipment having a function of forwarding, or one or some components or assemblies configured in the NCR or the network device or the terminal equipment.

FIG. 4 is a schematic diagram of the repeater of the embodiments of this disclosure. As a principle of the repeater for solving problems is similar to that of the method in the embodiments of the first aspect, reference may be made to the embodiments of the first aspect for implementation of the repeater, with identical contents being not going to be described herein any further.

As shown in FIG. 4, the repeater 400 includes:
a receiving unit 401 configured to receive first configuration information and/or second configuration information and/or third configuration information related to a first DCI format, wherein the first configuration information is used to configure a list of time domain resources, and/or, the second configuration information is used to configure an RNTI for scrambling the first DCI format, and/or, the third configuration information is used to configure a search space for monitoring the first DCI format; and
receive downlink control information using the first DCI format.

Reference may be made to the embodiments of the first aspect for implementations of the configuration information and downlink control information.

Furthermore, for the sake of simplicity, connection relationships between the components or modules or signal profiles thereof are only illustrated in FIG. 4. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Fourth Aspect

The embodiments of this disclosure provide a network device.

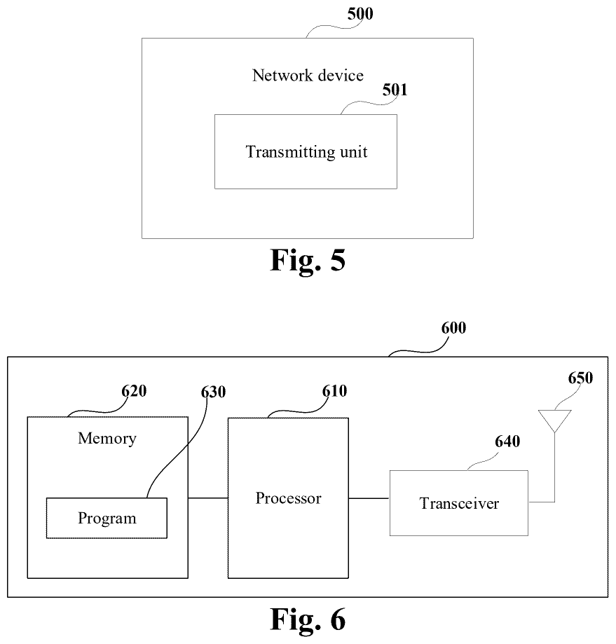

FIG. 5 is a schematic diagram of the network device of the embodiments of this disclosure. As a principle of the network device for solving problems is similar to that of the method in the embodiments of the second aspect, reference may be made to the implementation of the method described in the embodiments of the second aspect for implementation of the network device, with identical or related contents being not going to be described herein any further.

As shown in FIG. 5, the network device 500 of the embodiments of this disclosure includes:
a transmitting unit 501 configured to transmit first configuration information and/or second configuration information and/or third configuration information related to a first DCI format to a repeater, wherein the first configuration information is used to configure a list of time domain resources, and/or, the second configuration information is used to configure an RNTI for scrambling the first DCI format, and/or, the third configuration information is used to configure a search space for monitoring the first DCI format; and
the transmitting unit 501 is further configured to transmit downlink control information using the first DCI format.

Reference may be made to the embodiments of the first aspect for implementations of the configuration information and downlink control information.

It should be noted that the components or modules related to this disclosure are only described above. However, this disclosure is not limited thereto, and the network device 500 of the embodiments of this disclosure may further include other components or modules, and reference may be made to related techniques for particulars of these components or modules.

Furthermore, for the sake of simplicity, connection relationships between the components or modules or signal profiles thereof are only illustrated in FIG. 5. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Fifth Aspect

The embodiments of this disclosure provide a communication system. FIG. 1 is a schematic diagram of the communication system of the embodiments of this disclosure. As shown in FIG. 1, the communication system includes a network device 101, a repeater 102 and a terminal equipment 103. For the sake of simplicity, description is given in FIG. 1 by taking one network device, one repeater and two terminal equipments only as an example; however, the embodiments of this disclosure are not limited thereto.

In the embodiments of this disclosure, existing traffics or traffics that may be implemented in the future may be performed between the network device 101 and the terminal equipment 103. For example, such traffics may include but not limited to enhanced mobile broadband (eMBB), massive machine type communication (mMTC), ultra-reliable and low-latency communication (URLLC), and vehicle to everything (V2X) communication, etc. The repeater 102 is configured to execute the method for receiving information in the embodiments of the first aspect, and the network device 101 is configured to execute the method for transmitting information in the embodiments of the second aspect, contents of which being incorporated herein, which shall not be repeated herein any further.

The embodiments of this disclosure further provide an electronic device, which may be, for example, a repeater or a network device.

FIG. 6 is a schematic diagram of a structure of the electronic device of the embodiments of this disclosure. As shown in FIG. 6, the electronic device 600 may include a processor 610 (such as a central processing unit (CPU)) and a memory 620, the memory 620 being coupled to the processor 610. Wherein, the memory 620 may store various data, and furthermore, it may store a program 630 for information processing, and execute the program 630 under control of the processor 610.

For example, the processor 610 may be configured to execute a program to execute the information transmitting method described in the embodiments of the second aspect.

For another example, the processor 610 may be configured to execute a program to execute the information receiving method described in the embodiments of the first aspect.

Furthermore, as shown in FIG. 6, the electronic device 600 may include a transceiver 640, and an antenna 650, etc. Wherein, functions of the above components are similar to those in the related art, and shall not be described herein any further. It should be noted that the electronic device 600 does not necessarily include all the parts shown in FIG. 6, and furthermore, the electronic device 600 may include parts not shown in FIG. 6, and the related art may be referred to.

Embodiments of this disclosure provide a computer readable program, which, when executed in a network device, will cause a computer to carry out the information transmitting method described in the embodiments of the second aspect in the network device.

Embodiments of this disclosure provide a storage medium, including a computer readable program, which will cause a computer to carry out the information transmitting method described in the embodiments of the second aspect in the network device.

Embodiments of this disclosure provide a computer readable program, which, when executed in a repeater, will cause a computer to carry out the information receiving method described in the embodiments of the first aspect in the repeater.

Embodiments of this disclosure provide a storage medium, including a computer readable program, which will cause a computer to carry out the information receiving method described in the embodiments of the first aspect in the repeater.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile termination, and may also be stored in a memory card of a pluggable mobile termination. For example, if equipment (such as a mobile termination) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

1. An information receiving method, applicable to a repeater, characterized in that the method comprises:
receiving first configuration information and/or second configuration information and/or third configuration information related to a first DCI format by the repeater, wherein the first configuration information is used to configure a list of time domain resources, and/or, the second configuration information is used to configure an RNTI for scrambling the first DCI format, and/or, the third configuration information is used to configure a search space for monitoring the first DCI format; and
receiving downlink control information using the first DCI format by the repeater.

1a. The method according to supplement 1, the first DCI format is only used for repeater.

1b. The method according to supplement 1 or 1a, wherein the first DCI format or the DCI is used for carrying a (aperiodic or dynamic) beam indication or side control information, and/or used for transmission or notification of a (aperiodic or dynamic) beam indication or side control information for an access link, and/or used for indicating (aperiodic or dynamic) forwarding time resources or forwarding resources, and/or used for indicating that the repeater or a forwarding unit of the repeater being ON, and/or used for indicating that an access link and/or a backhaul link being ON, and/or used for (aperiodically or dynamically) indicating an access link beam and/or time resources.

1c. The method according to supplement 1 or 1a or 1b, wherein the first DCI format and/or the DCI comprise(s) a first information field, and comprise(s) or do/does not comprise a second information field.

2. The method according to any one of supplements 1-1c, wherein each/all downlink control information using the first DCI format (received by the repeater) comprises the same number of first information fields and/or second information fields and/or information blocks.

3. The method according to either one of supplements 1 and 2, wherein each/all downlink control information using the first DCI format (received by the repeater) does not comprise a second information field.

4. The method according to any one of supplements 1-1c, wherein different downlink control information using the first DCI format (received by the repeater) comprises different numbers of first information fields and/or second information fields and/or information blocks.

5. The method according to any one of supplements 1-4, wherein the first information field is used to indicate being ON (of the forwarding unit of the repeater) and/or used to indicate a beam (for the access link of the repeater/the forwarding unit of the repeater), and/or, the second information field is used to indicate (aperiodic) forwarding time resources or time resources, and/or, the information block comprises one first information field and one second information field.

6. The method according to any one of supplements 1-5, wherein the one first configuration information comprises one or more pieces of the following information:
first information used for indicating a first value M;
second information used for adding and/or modifying a time domain resource;
third information used for releasing a time domain resource;
fourth information used for indicating a subcarrier spacing;
fifth information used for indicating a bitwidth of a first information field;
sixth information used for indicating a bitwidth of a second information field; and
seventh information used for indicating a payload size of a first DCI format.

7. The method according to supplement 6, wherein the method further comprises:
determining a bitwidth(s) of one or more second information fields, and/or that a bitwidth of the second information field is greater than or equal to or not less than ┌log₂(I)┐ bits, or ┌log₂(I+N₁)┐ bits, or ┌log₂(I−N₂)┐ bits, or ┌log₂(I+N₁−N₂)┐ bits, by the repeater according to the sixth information.

7a. The method according to any one of supplements 1-7, wherein in each/all downlink control information using the first DCI format (received by the repeater), bitwidths of first information fields with identical sequence numbers are identical, and/or, bitwidths of second information fields with identical sequence numbers are identical.

8. The method according to any one of supplements 1-6, wherein the method further comprises:
determining a bitwidth of a second information field (of the first DCI format or DCI) by the repeater according to a first parameter I and/or second information and/or third information and/or a second parameter N₁ and/or a third parameter N₂.

9. The method according to supplement 8, wherein the bitwidth of the second information field is greater than or equal to or less than ┌log₂(I)┐ bits.

10. The method according to supplement 8 or 9, wherein the bitwidth of the second information field is equal to ┌log₂(I)┐ bits, or ┌log₂(I+N₁)┐ bits, or ┌log₂(I−N₂)┐ bits, or ┌log₂(I+N₁-N₂)┐ bits, or ┌log₂(I+N₁−N₂−O)┐ bits.

11. The method according to any one of supplements 7-10, wherein the first parameter I is equal to the number of time domain resources in a first time domain resource set or a second time domain resource set, and/or, the second parameter N₁ is equal to a predefined second value and/or a second value configured by ninth information and/or is related to the number of first specific values and/or second specific values, and/or, the third parameter N₂ is equal to a predefined third value and/or a third value configured by eighth information and/or is related to a position of a second information field, and a fourth parameter O denotes the number of time domain resources in the list of time domain resources or first time domain resource set or second time domain resource set that overlap with time domain resources indicated by one or more second information fields before the second information field.

12. The method according to supplement 11, wherein the first time domain resource set is the list of time domain resources, and/or, the second time domain resource set comprises a part or all of time domain resources in the list of time domain resources.

13. The method according to any one of supplements 1-12, wherein bitwidths or methods for determining bitwidths of at least two second information fields (in the first DCI format or DCI) are different, or, bitwidths or methods for determining bitwidths of all second information fields are identical.

14. The method according to any one of supplements 6-11, wherein the number of time domain resources in the list of time domain resources is equal to the number of entries included in the second information.

15. The method according to supplement 14, wherein the list of time domain resources is configured by the second information.

16. The method according to any one of supplements 6-11, wherein the number of time domain resources in the list of time domain resources is equal to the number of time domain resources configured by the second information and not released by the third information.

17. The method according to supplement 16, wherein the list of time domain resources is configured by the second information and the third information.

18. The method according to any one of supplements 6-11, wherein the repeater determines the list of time domain resources and/or the number of time domain resources in the list of time domain resources according to the second information and/or the third information.

19. The method according to any one of supplements 1-18, wherein an n-th value of a second information field (of the first DCI format or DCI) corresponds to a time domain resource with an index configured as n−1 or n in the first time domain resource set or the second time domain resource set, and/or, the n-th value of the second information field corresponds to an n-th time domain resource in the first time domain resource set or the second time domain resource set (where, n is an integer greater than or equal to 1).

20. The method according to any one of supplements 1-18, wherein an (n+N₃)-th value of the second information field corresponds to a time domain resource with an index configured as n−1 or n in the first time domain resource set or the second time domain resource set, and/or, the (n+N₃)-th value of the second information field corresponds to an n-th time domain resource in the first time domain resource set or the second time domain resource set (where, n is an integer greater than or equal to 1).

21. The method according to any one of supplements 1-18, wherein an index of the n-th time domain resource in the list of time domain resources or the first or second time domain resource set is configured as n or n−1, or, an index of the n-th time domain resource in the list of time domain resources or the first or second time domain resource set is configured as being different from n or n−1 (where, n is an integer greater than or equal to 1).

22. The method according to any one of supplements 1-21, wherein downlink control information using the first DCI format (received by the repeater) comprises a second information field set to be a first specific value, and the second information field and/or a second information field after the second information field does/do not indicate time domain resources and/or is/are invalid and/or is/are set to be a second specific value and/or is/are ignored by the repeater, and/or, a first information field to which the second information field corresponds and/or a first information field to which a second information field after the second information field corresponds does/do not indicate a beam and/or is/are invalid and/or is/are set to be a fourth specific value and/or is/are ignored by the repeater, and/or, an information field after the second information field is invalid and/or is set to be a fifth specific value and/or is ignored by the repeater, and/or, a first information field included in an information block where the second information field is located does not indicate a beam and/or is invalid and/or is set to be a fourth specific value and/or is ignored by the repeater, and/or, a first information field included in an information block after the information block where the second information field is located does not indicate a beam and/or is invalid and/or is set to be a fourth specific value and/or is ignored by the repeater, and/or, a second information field included in an information block after the information block where the second information field is located does not indicate time domain resources and/or is invalid and/or is set to be a second specific value and/or is ignored by the repeater.

23. The method according to any one of supplements 1-22, wherein downlink control information using the first DCI format (received by the repeater) comprises a second information field set to be a first specific value, the second information field being a last information field (of the downlink control information), and/or, an information block where the second information field is located being a last information block (of the downlink control information), and/or, the second information field being a last second information field (of the downlink control information), and/or, a first information field to which the second information field corresponds being a last first information field (of the downlink control information), and/or, the second information field having no corresponding first information field.

24. The method according to any one of supplements 1-23, wherein when a second information field before a second information field in the downlink control information using the first DCI format is set to be the first specific value and/or a first information field therebefore is set to be a third specific value and/or a first information field to which the second information field corresponds is set to be the third specific value, the second information field is of the second specific value.

25. The method according to any one of supplements 1-24, wherein all first ones of the second information fields in each/all downlink control information using the first DCI format are not set to be the first specific value, and/or are not set to be the second specific value.

26. The method according to any one of supplements 1-25, wherein the downlink control information using the first DCI format (received by the repeater) comprises a first information field set to be the third specific value, wherein the first information field and/or a first information field after the first information field does/do not indicate a beam and/or is/are invalid and/or is/are set to be the fourth specific value and/or is/are ignored by the repeater, and/or, a second information field to which the first information field corresponds and/or a second information field to which a first information field after the first information field corresponds does/do not indicate time domain resources and/or is/are invalid and/or is/are set to be the second specific value and/or is/are ignored by the repeater, and/or, an information field after the first information field is invalid and/or is set to be a sixth specific value and/or is ignored by the repeater, and/or, a second information field included in an information block where the first information field is located does not indicate time domain resources and/or is invalid and/or is set to be the second specific value and/or is ignored by the repeater, and/or, a second information field included in an information block after an information block where the first information field is located does not indicate time domain resources and/or is invalid and/or is set to be the second specific value and/or is ignored by the repeater, and/or, a first information field included in an information block after the information block where the first information field is located does not indicate a beam and/or is invalid and/or is set to be the fourth specific value and/or is ignored by the repeater.

27. The method according to any one of supplements 1-26, wherein downlink control information using the first DCI format (received by the repeater) comprises a first information field set to be third specific value, the first information field being a last information field (of the downlink control information), and/or, an information block where the first information field is located being a last information block (of the downlink control information), and/or, the first information field being a last first information field (of the downlink control information), and/or, a second information field to which the first information field corresponds being a last second information field (of the downlink control information), and/or, the first information field having no corresponding second information field.

28. The method according to any one of supplements 1-27, wherein when a first information field before one first information field in the downlink control information using the first DCI format is set to be the third specific value and/or a second information field therebefore is set to be the second specific value and/or a second information field to which the one first information field corresponds is set to be the second specific value, the one first information field is of the fourth specific value.

29. The method according to any one of supplements 1-28, wherein all first ones of first information fields in each/all downlink control information using the first DCI format are not set to be the third specific value, and/or are not set to be the fourth specific value.

30. The method according to supplement 6, wherein the first value M is greater than or equal to the number of first information fields and/or the number of second information fields and/or information blocks included in the first DCI format, and/or is greater than or equal to a maximum sequence number (or a maximum sequence number+1) of first information fields and/or a maximum sequence number (or a maximum sequence number+1) of second information fields and/or a maximum sequence number (or a maximum sequence number+1) of information blocks included in the first DCI format, and/or is greater than or equal to a sequence number (or a sequence number+1) of a last first information field and/or a sequence number (or a sequence number+1) of a last second information field and/or a sequence number (or a sequence number+1) of a last information block included in the first DCI format, and/or is greater than or equal to the number of the first information fields and/or the number of second information fields and/or the information blocks included in the DCI, and/or is greater than or equal to a maximum sequence number (or a maximum sequence number+1) of the first information fields and/or a maximum sequence number (or a maximum sequence number+1) of the second information fields and/or a maximum sequence number (or a maximum sequence number+1) of the information blocks included in the DCI, and/or is greater than or equal to a sequence number (or a sequence number+1) of a last first information field and/or a sequence number (or a sequence number+1) of a last second information field and/or a sequence number (or a sequence number+1) of a last information block included in the DCI.

31. The method according to supplement 6 or 30, wherein the first value denotes (or, the first information is used to indicate) the number of first information fields and/or the number of second information fields and/or the number of information blocks included in the DCI format, and/or, a maximum sequence number (or a maximum sequence number+1) of the first information fields and/or a maximum sequence number (or a maximum sequence number+1) of the second information fields and/or a maximum sequence number (or a maximum sequence number+1) of the information blocks included in the DCI format, and/or, a sequence number (or a sequence number+1) of a last first information field and/or a sequence number (or a sequence number+1) of a last second information field and/or a sequence number (or a sequence number+1) of a last information block included in the DCI format, and/or, a maximum number of the first information fields and/or a maximum number of second information fields and/or a maximum number of information blocks possibly included in the DCI, and/or, the number of first information fields and/or the number of second information fields and/or the number of information blocks included in the DCI, and/or, a maximum sequence number (or a maximum sequence number+1) of the first information fields and/or a maximum sequence number (or a maximum sequence number+1) of the second information fields and/or a maximum sequence number (or a maximum sequence number+1) of the information blocks included in the DCI, and/or, a sequence number (or a sequence number+1) of a last first information field and/or a sequence number (or a sequence number+1) of a last second information field and/or a sequence number (or a sequence number+1) of a last information block included in the DCI.

32. The method according to supplement 2 or 6 or 30 or 31, wherein the numbers of the first information fields and/or the numbers of the second information fields and/or the numbers of the information blocks included in each/all DCI using the first DCI format are all equal to the first value.

33. The method according to supplement 2 or 6 or 30 or 31, wherein the numbers of the first information fields and/or the numbers of the second information fields included in each/all DCI using the first DCI format are all less than the first value.

34. The method according to supplement 4 or 6 or 30 or 31, wherein the numbers of the first information fields and/or the numbers of the second information fields and/or the numbers of the information blocks included in one DCI using the first DCI format are less than or equal to the first value.

35. The method according to supplement 1 or 4 or 34, wherein the number of the first information fields and/or the number of the second information fields and/or the number of the information blocks included in one downlink control information using the first DCI format is/are related to value(s) of the first information fields and/or the second information fields included in the one DCI.

36. The method according to supplement 1 or 33, wherein numbers of the second information fields included in each/all DCI using the first DCI format are related to the list of time domain resources.

37. The method according to any one of supplements 1-36, wherein the list of time domain resources at least comprises a time domain resource or at least comprises two time domain resources; and/or,
the number of time domain resources included in the list of time domain resources and/or the number of entries included in the second information and/or the number of time domain resources configured by the second information and not released/removed by the third information is/are greater than or equal to the number of the second information fields included in the downlink control information using the first DCI format and/or the number of the first information fields included in the downlink control information and/or the first value; and/or,
the number of non-overlapped time domain resources included in the list of time domain resources and/or the number of entries of configurations as being non-overlapped included in the second information and/or the number of non-overlapped time domain resources configured by the second information and not released/removed by the third information is/are greater than or equal to the number of the second information fields included in the downlink control information using the first DCI format and/or the number of the first information fields included in the downlink control information and/or the first value.

38. An information transmitting method, applicable to a network device, characterized in that the method comprises:
transmitting first configuration information and/or second configuration information and/or third configuration information related to a first DCI format by the network device (to a repeater), wherein the first configuration information is used to configure a list of time domain resources, and/or, the second configuration information is used to configure a radio network temporary identity (RNTI) for scrambling the first DCI format, and/or, the third configuration information is used to configure a search space for monitoring the first DCI format; and
transmitting downlink control information using the first DCI format by the network device (to the repeater).

39. A network device, including a memory and a processor, the memory storing a computer program, and the processor being configured to execute the computer program to carry out the method as described in supplement 38.

40. A repeater, including a memory and a processor, the memory storing a computer program, and the processor being configured to execute the computer program to carry out the method as described in any one of supplements 1-37.

1. A repeater, comprising:
a receiver configured to:
receive a RRC signaling including first configuration information, second configuration information and third configuration information, the first configuration information being used to configure a list of time domain resources, the second configuration information being used to configure a radio network temporary identity (RNTI) for scrambling a first DCI format, the third configuration information being used to configure a search space for monitoring the first DCI format; and
receive the first DCI format; the first DCI format comprising a first information field used to indicate a beam for access link and a second information field used to indicate a time domain resource from the time domain resources configured by the first configuration information; and
a forwarding entity configured to perform forwarding on the access link by using the beam and the time domain resource.

2. The repeater according to claim 1, wherein the first DCI format comprises the same number of first information fields and/or second information fields and/or information blocks.

3. The repeater according to claim 2, wherein the first information field is used to indicate a beam, and/or, the second information field is used to indicate forwarding time resources or time resources, and/or, the information block comprises one first information field and one second information field.

4. The repeater according to claim 1, wherein first configuration information comprises one or more of the following information:
first information used for indicating a first value which is equal to the number of first information fields in the first DCI format and equal to the number of second information fields in the first DCI format;
second information used for adding and/or modifying a time domain resource in the list of time domain resources;
third information used for releasing a time domain resource in the list of time domain resources;
fourth information used for indicating a subcarrier spacing;
fifth information used for indicating a bitwidth of a first information field in the first DCI format.

5. The repeater according to claim 1, the repeater further comprising:
processor circuitry configured to determine a bitwidth of the second information field according to a first parameter I and/or second information and/or third information and/or a second parameter N₁ and/or a third parameter N₂ and/or a fourth parameter O.

6. The repeater according to claim 5, wherein the bitwidth of the second information field is equal to ┌log₂(I)┐ bits, or ┌log₂(I+N₁)┐ bits, or ┌log₂(I−N₂)┐ bits, or ┌log₂(I+N₁−N₂)┐ bits, or, ┌log₂(I+N₁−N₂−O)┐ bits.

7. The repeater according to claim 1, the repeater further comprising:
processor circuitry configured to determine a bitwidth of a second information field in the first DCI format according to the number of time domain resources configured by the first configuration information,
wherein, the bitwidth of the second information field is larger or equal to ┌log₂(I)┐ bits, the parameter I being equal to the number of time domain resources configured by the first configuration information.

8. The repeater according to claim 1, wherein values of a second information field are mapped to time domain resources configured by the first configuration information according to an ascending order of a resource identity, with a smallest value of the second information field mapped to a time domain resource with a smallest resource identity.

9. The repeater according to claim 5, wherein the first parameter I is equal to the number of time domain resources in a first time domain resource set or a second time domain resource set, and/or, the second parameter N₁ is equal to a predefined second value and/or a second value configured by ninth information and/or is related to the number of first specific values and/or second specific values, and/or, the third parameter N₂ is equal to a predefined third value and/or a third value configured by eighth information and/or is related to a position of a second information field, and a fourth parameter O denotes the number of time domain resources in the list of time domain resources or first time domain resource set or second time domain resource set that overlap with time domain resources indicated by one or more second information fields before the second information field.

10. The repeater according to claim 9, wherein the first time domain resource set is the list of time domain resources, and/or, the second time domain resource set comprises a part or all of time domain resources in the list of time domain resources.

11. The repeater according to claim 1, wherein the first DCI format comprises a second information field set to be a first specific value, and the second information field and/or a second information field after the second information field does/do not indicate time domain resources and/or is/are invalid and/or is/are set to be a second specific value and/or is/are ignored by the repeater, and/or, a first information field to which the second information field corresponds and/or a first information field to which a second information field after the second information field corresponds does/do not indicate a beam and/or is/are invalid and/or is/are set to be a fourth specific value and/or is/are ignored by the repeater, and/or, an information field after the second information field is invalid and/or is set to be a fifth specific value and/or is ignored by the repeater, and/or, a first information field included in an information block where the second information field is located does not indicate a beam and/or is invalid and/or is set to be a fourth specific value and/or is ignored by the repeater, and/or, a first information field included in an information block after the information block where the second information field is located does not indicate a beam and/or is invalid and/or is set to be a fourth specific value and/or is ignored by the repeater, and/or, a second information field included in an information block after the information block where the second information field is located does not indicate time domain resources and/or is invalid and/or is set to be a second specific value and/or is ignored by the repeater.

12. The repeater according to claim 1, wherein the first DCI format comprises a second information field set to be a first specific value, the second information field being a last information field, and/or, an information block where the second information field is located being a last information block, and/or, the second information field being a last second information field, and/or, a first information field to which the second information field corresponds being a last first information field, and/or, the second information field having no corresponding first information field.

13. The repeater according to claim 1, wherein all first ones of the second information fields in each/all downlink control information using the first DCI format are not set to be the first specific value, and/or are not set to be the second specific value.

14. The repeater according to claim 4, wherein the first value is greater than or equal to the number of first information fields and/or the number of second information fields and/or information blocks included in the first DCI format, and/or is greater than or equal to a maximum sequence number of first information fields and/or a maximum sequence number of second information fields and/or a maximum sequence number of information blocks included in the first DCI format, and/or is greater than or equal to a sequence number of a last first information field and/or a sequence number of a last second information field and/or a sequence number of a last information block included in the first DCI format, and/or is greater than or equal to the number of the first information fields and/or the number of second information fields and/or the information blocks included in the DCI, and/or is greater than or equal to a maximum sequence number of the first information fields and/or a maximum sequence number of the second information fields and/or a maximum sequence number of the information blocks included in the DCI, and/or is greater than or equal to a sequence number of a last first information field and/or a sequence number of a last second information field and/or a sequence number of a last information block included in the DCI.

15. The repeater according to claim 4, wherein the first value denotes the number of first information fields and/or the number of second information fields and/or the number of information blocks included in the DCI format, and/or, a maximum sequence number of the first information fields and/or a maximum sequence number of the second information fields and/or a maximum sequence number of the information blocks included in the DCI format, and/or, a sequence number of a last first information field and/or a sequence number of a last second information field and/or a sequence number of a last information block included in the DCI format, and/or, a maximum number of the first information fields and/or a maximum number of second information fields and/or a maximum number of information blocks possibly included in the DCI, and/or, the number of first information fields and/or the number of second information fields and/or the number of information blocks included in the DCI, and/or, a maximum sequence number of the first information fields and/or a maximum sequence number of the second information fields and/or a maximum sequence number of the information blocks included in the DCI, and/or, a sequence number of a last first information field and/or a sequence number of a last second information field and/or a sequence number of a last information block included in the DCI.

16. The repeater according to claim 1, wherein the numbers of the first information fields and/or the numbers of the second information fields and/or the numbers of the information blocks included in one DCI using the first DCI format are related to value(s) of the first information fields and/or the second information fields included in the one DCI.

17. The repeater according to claim 1, wherein numbers of the second information fields included in the first DCI format are related to the list of time domain resources.

18. The repeater according to claim 1, wherein the list of time domain resources at least comprises a time domain resource or at least comprises two time domain resources; and/or,
the number of time domain resources included in the list of time domain resources and/or the number of entries included in the second information and/or the number of time domain resources configured by the second information and not released/removed by the third information is/are greater than or equal to the number of the second information fields included in the downlink control information using the first DCI format and/or the number of the first information fields included in the downlink control information and/or the first value; and/or,
the number of non-overlapped time domain resources included in the list of time domain resources and/or the number of entries of configurations as being non-overlapped included in the second information and/or the number of non-overlapped time domain resources configured by the second information and not released/removed by the third information is/are greater than or equal to the number of the second information fields included in the downlink control information using the first DCI format and/or the number of the first information fields included in the downlink control information and/or the first value.

19. A network device, comprising:
a transmitter configured to transmit a RRC signaling including first configuration information, second configuration information and third configuration information, the first configuration information being used to configure a list of time domain resources, the second configuration information being used to configure a radio network temporary identity (RNTI) for scrambling a first DCI format, the third configuration information being used to configure a search space for monitoring the first DCI format; and
the transmitter is further configured to transmit the first DCI format, the first DCI format comprising a first information field used to indicate a beam for access link and a second information field used to indicate a time domain resource from the time domain resources configured by the first configuration information.

20. A communication system, comprising:
a network device configured to:
transmit a RRC signaling including first configuration information, second configuration information, and third configuration information, the first configuration information being used to configure a list of time domain resources, the second configuration information being used to configure a radio network temporary identity (RNTI) for scrambling a first DCI format, the third configuration information being used to configure a search space for monitoring the first DCI format, and
transmit the first DCI format, the first DCI format comprising a first information field used to indicate a beam for access link and a second information field used to indicate a time domain resource from the time domain resources configured by the first configuration information; and
a repeater configured to perform forwarding on the access link by using the beam and the time domain resource.
